(19) United States
(12) Patent Application Publication
(10) Pub. No.: US 2007/0220516 A1
(43) Pub. Date: Sep. 20, 2007

(54) Program, apparatus and method for distributing batch job in multiple server environment

(75) Inventors: Tatsushi Ishiguro, Kawasaki (JP); Kazuyoshi Watanabe, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/471,813

(22) Filed: Jun. 21, 2006

(30) Foreign Application Priority Data
Mar. 15, 2006 (JP) 2006-070814

(51) Int. Cl. G06F 9/46

(52) U.S. Cl. 718/101

(57) ABSTRACT

Using a batch job characteristic and input data volume, the time required for the execution of the batch job is predicted, the load status of each execution server over the range of the time is predicted, and an execution server to execute the batch job is selected based on the predictions. Additionally, for every execution of the batch job, the load occurred by the batch job execution is measured and the batch job characteristic is updated based on the measurement. This measurement and update can improve reliability of the batch job characteristic and accuracy of the execution server selection.

### BACKGROUND OF THE INVENTION

1. Field of the Invention

The present invention relates to the technology for appropriately selecting a server to execute a batch job and for efficiently distributing the load in a multiple server environment where a plurality of servers executing a batch job are present.

2. Description of the Related Art

There has been a previous method to improve throughput by distributing a plurality of batch jobs across a plurality of servers, causing the servers to execute the distributed batch jobs. It is possible to determine the distribution statically; however, dynamic distribution can achieve a further efficient load distribution.

A system described in Patent Document 1 monitors load statuses of a plurality of servers executing batch jobs. When the batch job execution is requested, the system classifies the batch job into types (such as “CPU resource using type”, a type using CPU resources inmain rather thanmemory and I/O resources) based on a preset resource usage characteristic of the batch job, and selects a server in a load status appropriate for executing that type of job. A similar system is disclosed in Patent Document 2.

In a batch job system, unlike an online job system, batches of input data are processed together. Therefore, the batch job has a characteristic such that if one batch job is executed multiple times with each different input data volume, the amount of the used computer resources and the execution time depend on the input data volume (the number of transactions).

In many cases, to process a large input data volume, execution of a batch job requires a long time, for example one to two hours. Thus, there is a high probability that a server with a low load when the batch job started may have a high load while executing the batch job due to various factors, including factors other than the batch job. If the system causes such a server with a low load to execute the batch job based on the server load status at the start of the batch job, the optimal distribution cannot be achieved.

The systems described in Patent Document 1 and Patent Document 2, however, do not take into account the time factor required for batch job execution. Additionally, the server load status used to determine the batch job distribution is only the load status obtained immediately before/after the batch job execution request.

In the systems of Patent Document 1 and Patent Document 2, it is crucial to obtain the batch job characteristics properly. However, due to the amount of time and effort required, the conventional systems have difficulties obtaining batch job characteristics itself. Because there is no standard system or tool to visualize factors of batch job process time, such as the process data volume, the user resource conflict, the system resource conflict, waiting time occurring as a result of the conflict, and others in a comprehensive manner, a user needs to develop an application program on his/her own in order to obtain the batch job characteristics. The second reason is that although a server comprises a standard function to calculate the system loads for each process, the calculation for each batch job requires manual effort, or a user needs to create a specific application program.

Patent Document 1: Japanese Patent Application Publication No. 10-334057

Patent Document 2: Japanese Patent Application Publication No. 4-34640

### SUMMARY OF THE INVENTION

It is an object of the present invention to select an optimal server over a period of time required for the execution of batch jobs, in selecting a server to execute the batch job in a multiple server environment where a plurality of servers executing the batch jobs are present. It is another object of the present invention to reduce the difficulties of obtaining the batch job characteristics by automatically recording the batch job characteristics used in the selection.

The program according to the present invention is used in a batch job receiving computer for selecting a computer (i.e. server) to execute a batch job from a plurality of computers. The program according to the present invention causes the batch job receiving computer to predict the execution time required for the execution of the batch job based on a characteristic of the batch job and input data volume provided to the batch job. The batch job receiving computer also predicts each of the load statuses of a plurality of the computers in a time range with a scheduled batch job execution start time as a starting point and with a predicted execution time period. It additionally causes the batch job receiving computer to select a computer to execute the batch job from a plurality of the computers based on the predicted load status.

Preferably, the program according to the present invention further causes the batch job receiving computer to update the batch job characteristic based on information relating to a load that occurs when the batch job is executed by the above selected computer.

According to the present invention, a server load status not at a point in time but over a time period is predicted and a server to execute the batch job is selected based on the prediction. The time period is determined by predicting a required time for the batch job execution. Therefore, it is possible to select an appropriate server in executing a batch job that requires a long execution time, even in an environment where the load status of a plurality of servers changes according to a time period. Consequently, it is possible to distribute batch jobs more efficiently than in the past in a multiple server environment.

Because the batch job characteristics are generated and updated automatically, potential problems, such as effort by a system administrator etc. to obtain batch job characteristics, can be reduced. Furthermore, the reliability of the recorded batch job characteristics is enhanced as the collected volume of the data representing the batch job characteristics increase. Therefore, the accuracy of the server selection determination to execute the batch job can be improved, realizing a further efficient operation.

### BRIEF DESCRIPTION OF THE DRAWINGS

FIG. 1 is a diagram showing a principle of the present invention;

FIG. 2 is a graph showing an example of a load resulting from the execution of one batch job;

FIG. 3 is a graph showing an example of the load of a server executing the batch job;

FIG. 4 is a functional block diagram of an embodiment of the system according to the present invention for selecting a batch job execution server and causing the server to execute a distributed batch job;

FIG. 5 is an example of storing the operation data;

FIG. 6 shows an example of storing the batch job characteristics;

FIG. 7 is an example of storing the server load information;

FIG. 8 is an example of the distribution conditions;

FIG. 9 is a flowchart of the process executed in the batch job system;

FIG. 10 is a flowchart showing the process to determine the batch job execution server;

FIG. 11 is a flowchart showing the process for updating the batch job characteristics;

FIG. 12 is a flowchart showing the process for recording the server load information; and

FIG. 13 is a block diagram of a computer executing the program of the present invention.

### DESCRIPTION OF THE PREFERRED EMBODIMENT

In the following description, details of the embodiments of the present invention are set forth with reference to the drawings.

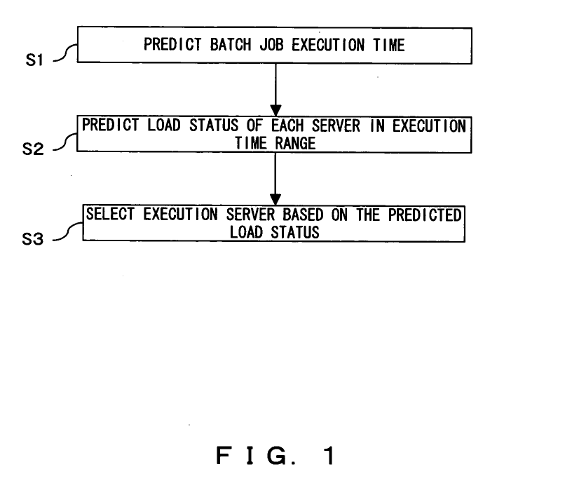

FIG. 1 is a diagram showing a principle of the present invention. A program according to the present invention is used to select a server to execute a batch job in a multiple server environment where a plurality of servers executing the batch job are present. The program according to the present invention predicts the execution time required to execute the batch job in step S1, based on the batch job characteristics and the input data volume. In step S2, the program predicts the load status of each server within the execution time range. In steps 3, finally, the program selects a server to execute the batch job based on the predicted load status. The selected server executes the batch job and an appropriate distribution of the batch job in a multiple server environment is realized.

In addition, for every batch job execution by the selected server, the program measures and records the load resulting from the execution and updates the batch job characteristics based on the recorded data.

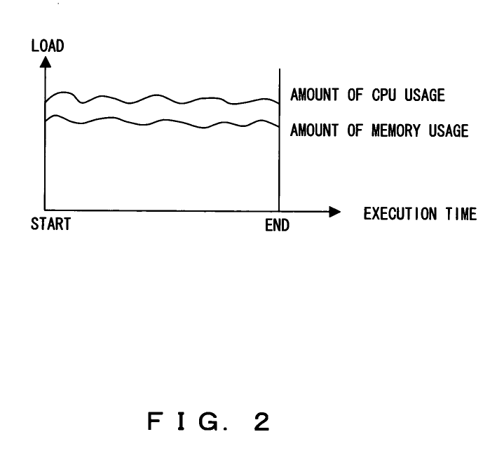

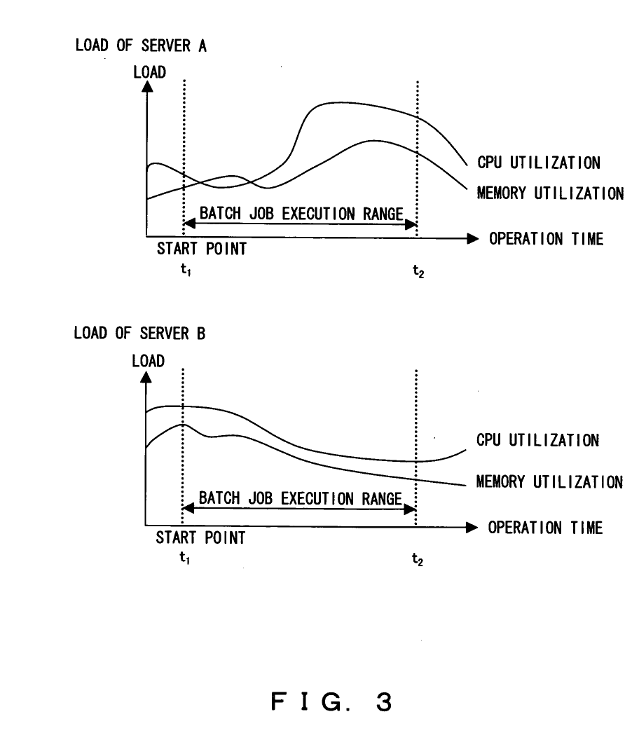

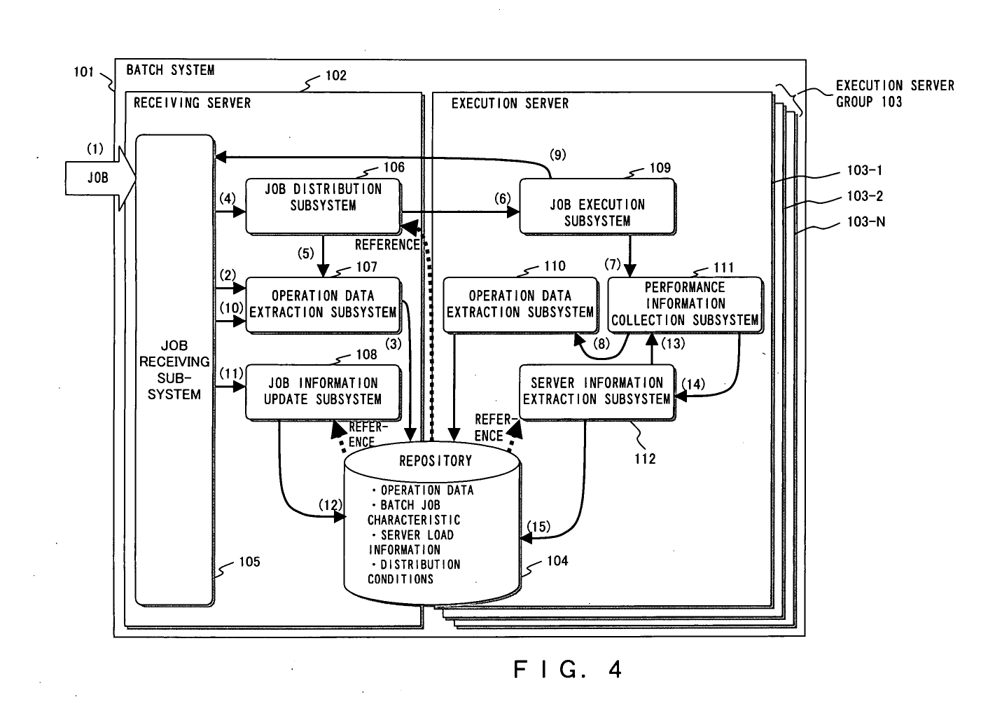

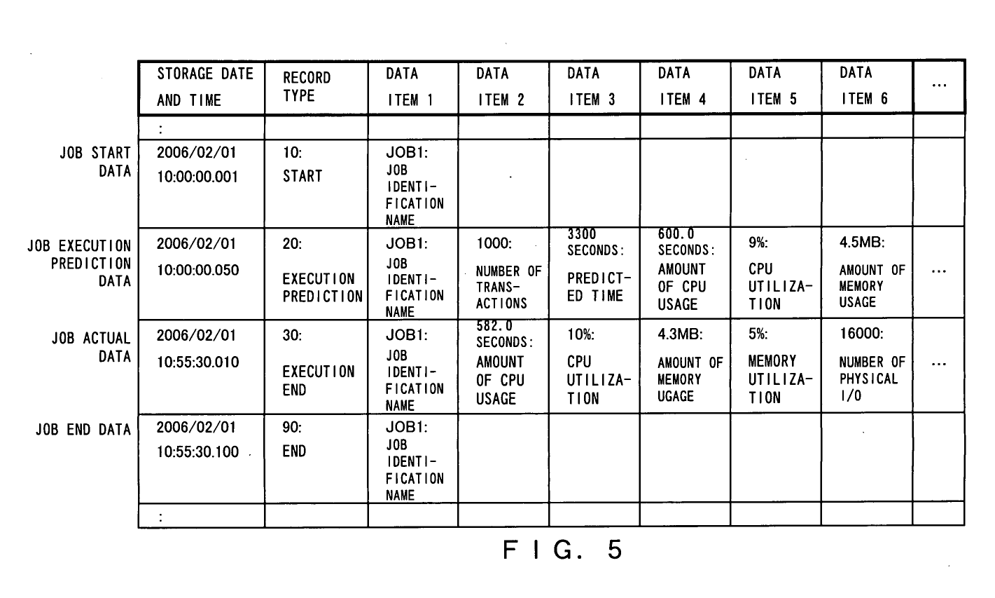

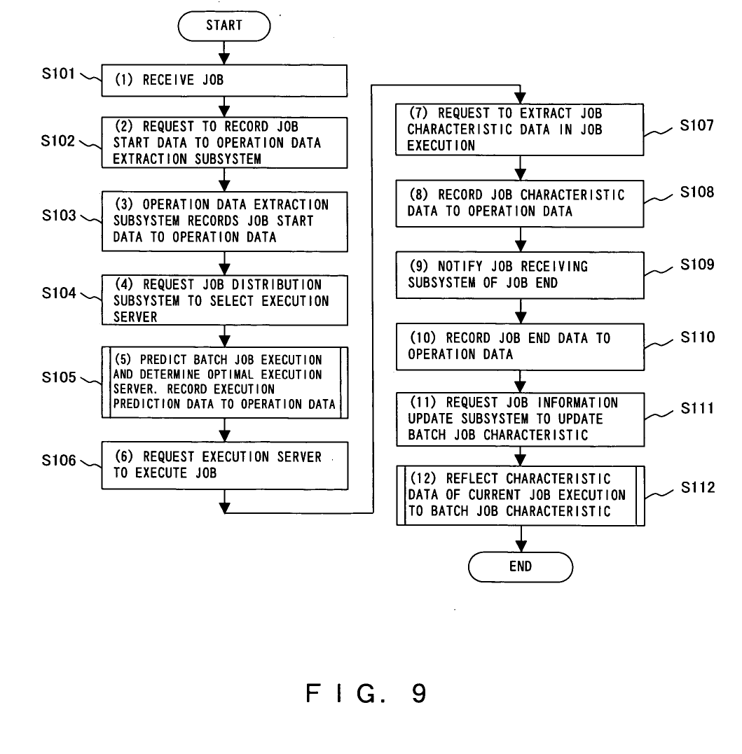

In the following description, first, the outline of a method for selecting a server executing a batch job is explained referencing to FIG. 2 and FIG. 3. Next, a whole configuration of the system, which selects a server executing the batch job and causes the server to execute a distributed batch job according to the present invention, is explained referencing to FIG. 4. Afterwards, various data configurations used in the present invention are explained using FIGS. 5-8, and flow of processes is explained using FIGS. 9-12.

FIG. 2 is a graph showing an example of load resulting from the execution of one batch job. The load is on the vertical axis and time is on the horizontal axis of the graph of FIG. 2. FIG. 2 shows two types of loads of the amount of CPU usage and the amount of memory usage. In general, many batch job systems perform a one-by-one sequential process of process target data, and therefore, the range of load fluctuation is small in many cases as shown in FIG. 2. Accordingly, the amount of the load can be approximated as constant rather than amount changing in accordance with time.

FIG. 3 is a graph showing an example of the load of a server executing the batch job. The load is on the vertical axis, and time is on the horizontal axis of the graph of FIG. 3. The example of FIG. 3 shows two types of load for CPU utilization and memory utilization for each of a server A and a server B. Because a server executes more than one batch job, the load may change significantly in accordance with time as shown in FIG. 3.

Suppose that there is a batch job scheduled to be started from a time t₁. As in the example of FIG. 3, server A's load is less than that of a server B at the time t₁. Since a server to execute the batch job is selected based on the load at the time t₁ in the conventional methods, the server A with a favorable CPU utilization and memory utilization is selected at the time t₁. However, it would not be an optimal load distribution to select server A, for the load of the server A tend to increase with time whereas the load of the server B tend to decrease with time.

For the purpose of simplifying the explanation, this description assumes that the differences between the hardware performances of server A and the server B is negligible. Then, the predicted time required to execute a batch job in server A is also the predicted time required to execute the batch job in server B (the prediction method is explained later). The predicted time is designated as d, and a time t₂ is a time defined as t₂=t₁+d. The range between time t₁ and time t₂ is a predicted time range from the execution start to the execution completion of the batch job. The predicted time range is hereinafter referred to as the batch job execution range. The present invention takes into account each load of the server A and the server B in the batch job execution range and selects a server to execute the batch job. In the example of FIG. 3, the total loading amount of server B is less than that of the server A in terms of both CPU utilization and memory utilization within the batch job execution range. Thus, server B is selected.

It should be noted that in the graph of FIG. 3, the total loading amount over the batch job execution range corresponds to the value of the CPU utilization or the value of the memory utilization, each being integrated from the time t₁ to the time t₂. The total loading amount over the batch job execution range can be predicted by quadrature by parts, conducted by separating the interval between t₁ to t₂ into a plurality of intervals in the same manner as commonly used to calculate an approximate value of integral.

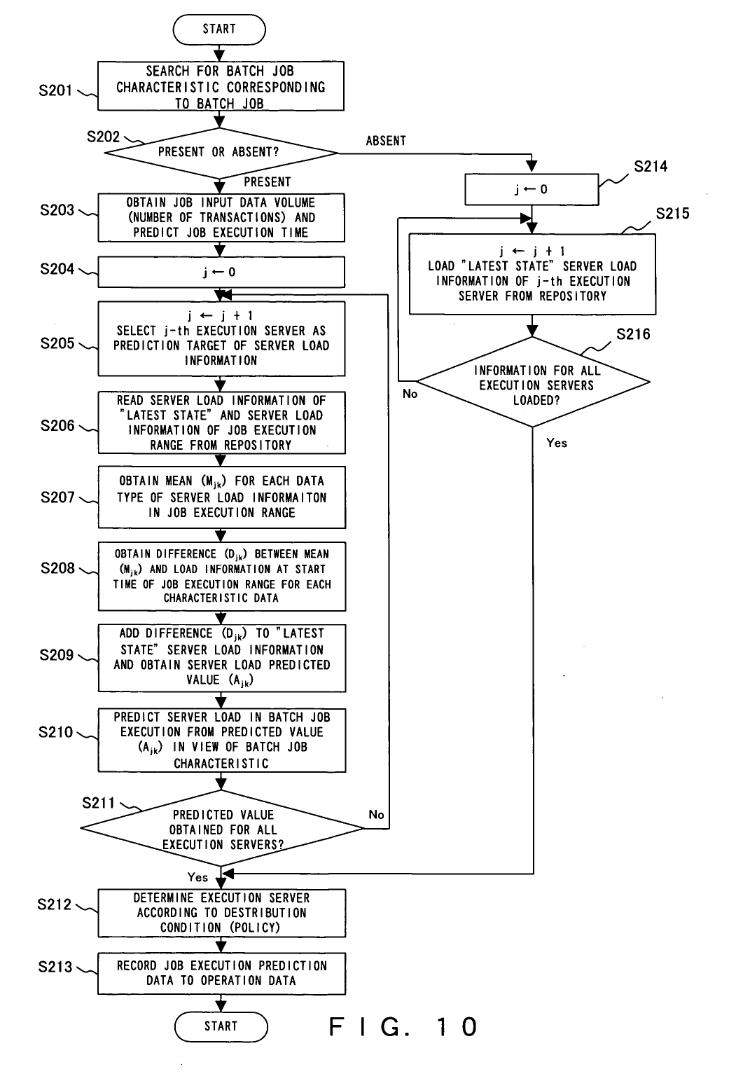

If the load generated by the batch job execution significantly changes (increases or decreases) within the execution range, matching the trend of the change and a trend of the server load change in the execution range needs to be considered when selecting a server to execute the batch job. In practice, however, the load caused by one batch job execution does not change significantly in many cases (FIG. 2). Therefore, the present invention does not take into account the change trend matching in determining a server to execute the batch job. In other words, the server is determined based on the total server loading amount without considering the server load change trend (increase or decrease) as shown in FIG. 3. The total server loading amount is proportional to the server loading mean value over the batch job execution range. Thus, it is possible to determine the server to execute the batch job by using the server loading mean value instead of the total server loading amount. The processes shown in the flowchart of FIG. 10 utilize this relationship.

FIG. 4 is a configuration diagram of an embodiment of the system according to the present invention for selecting a batch job execution server and causing the server to execute a distributed batch job. A batch system 101 shown in FIG. 4 comprises a receiving server 102, an execution server group 103 with a plurality of execution servers 103-1, 103-2, . . . , 103-N, and a repository 104. The receiving server 102, when receiving a batch job execution request, predicts the time required for the batch job execution and also predicts load status of each of the execution servers 103-1, 103-2, . . . , 103-N within the batch job execution range, selects an appropriate execution server from the execution server group 103 based on the predicted load status, and causes the execution server to execute the batch job. The receiving server performs the prediction and selection based on the data stored in the repository 104. The numbers from (1) to (15) in FIG. 4 denote process flow. Details are to be hereinafter described.

The receiving server 102 is a server computer that has a function to schedule the batch job (hereinafter referred to as “scheduling function”). Each of the execution servers 103-1, 103-2, . . . , 103-N is a server computer that has a function to execute the batch job (hereinafter referred to as “execution function”). In the following description, it is mainly assumed that the difference in performances of the execution servers 103-1, 103-2, . . . , 103-N is negligible. An example of such a situation is a case where execution servers with the similar performance are managed as clustered servers. The repository 104 is provided on a disk device (storage device), storing various data (FIGS. 5-8) required for batch job distribution. The receiving server 102 and the execution servers 103-1, 103-2, . . . , 103-N can access the disk device on which the repository 104 is provided and can reference/update etc. the data in the repository.

The scheduling function is present in one physical server (that is the receiving server 102). The execution function is present in more than one physical server (that is the execution servers 103-1, 103-2, . . . , 103-N). The receiving server 102 may be physically identical with one of the servers of the execution server group 103, or may be different from any of the servers in the execution server group 103.

The format of the disk device provided with the repository 104 has to be a format that can be referred by each server (the receiving server 102 and the execution servers 103-1, 103-2, . . . , 103-N) using the repository 104. However, the format does not have to be versatile, but can be a format unique to the batch system 101.

The repository 104 stores data indicating the system operation state (hereinafter referred to as “operation data”), data indicating characteristics of the batch job (hereinafter referred to as “batch job characteristics”), data indicating the server load status (hereinafter referred to as “server load information”), and rules for selecting an execution server to execute the batch job (hereinafter referred to as “distribution conditions”).

Each of the above information in the repository 104 may be stored in a file or may be stored in a plurality of separate files. The disk device provided with the repository 104 can be a disk device physically different from any of the local disks of the receiving server 102 and the execution servers 103-1, 103-2, . . . , 103-N, or can be a disk device physically identical with the local disk of any of the servers. It is also possible that the repository 104 is physically divided into and provided to more than one disk devices. For example, the batch job characteristics and the distribution conditions may be stored in a local disk of the receiving server 102, and the operation data and the server load information may be stored in a disk device that is physically different from any of the server local disk.

The operation data is data for managing the history of batch job execution and the history of the server load. An example of the operation data is shown in FIG. 5, and details are to be hereinafter described.

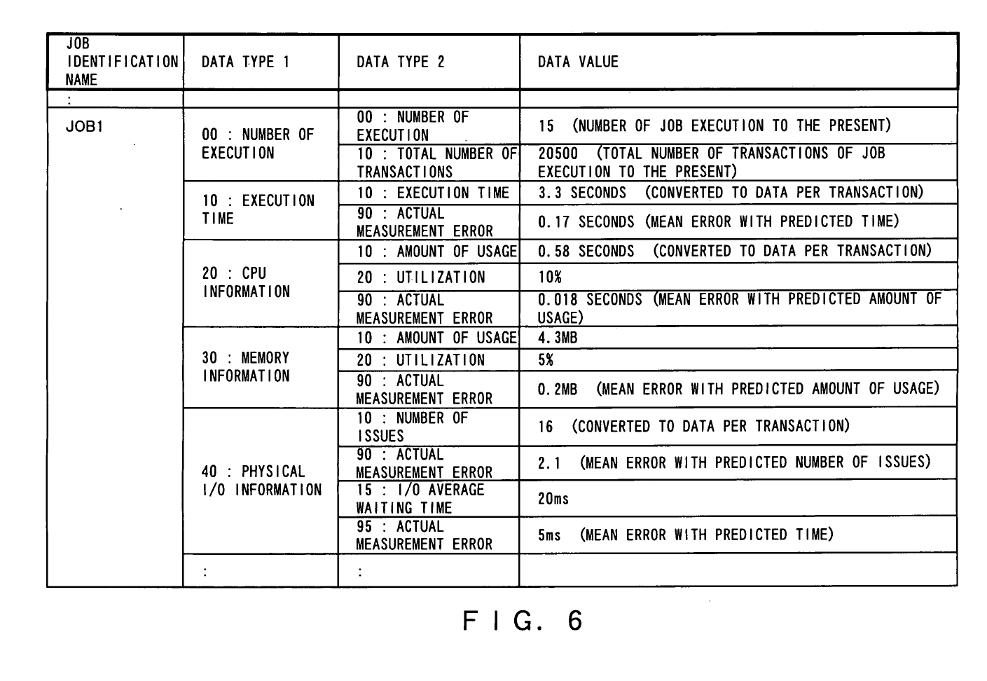

The batch job characteristics are generated by extracting the data for each batch job from the operation data shown in FIG. 5. The batch job characteristics are data for managing the characteristics of each batch job. The repository 104 may store items such as a job identification name, the number of job steps, an execution time, an amount of CPU usage, an amount of memory usage, and the number of physical I/O issued as batch job characteristics. Among the above items, necessary items are determined as the batch job characteristics depending on the embodiment and stored in the repository 104. An example of the batch job characteristics is shown in FIG. 6, and details are to be hereinafter described.

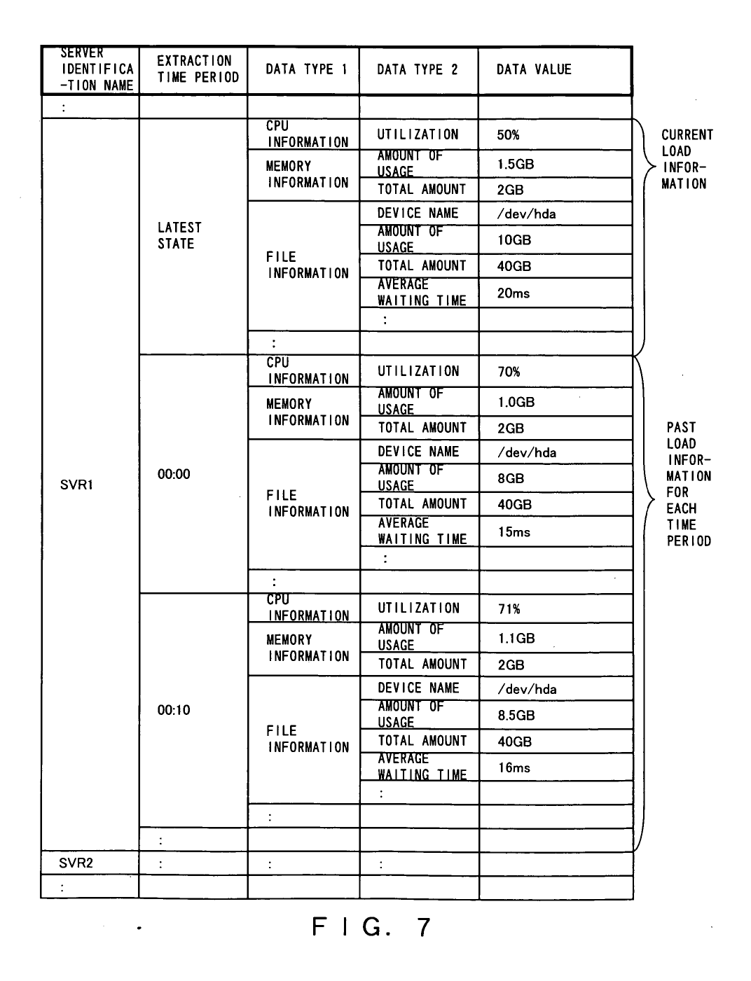

The server load information is information managing the load of each of the execution servers 103-1, 103-2, . . . , 103-N for each period of time. The repository 104 may store items such as the amount of CPU usage, the CPU utilization, the amount of memory usage, the memory utilization, the average waiting time of physical I/O, the amount of file usage, and free space of a storage device as the server load information. Among the above items, the necessary items are stored in the repository 104 as the server load information depending on the embodiment. An example of server load information is shown in FIG. 7, and details are to be hereinafter described.

The distribution conditions hold rules referred to when selecting a server to execute a batch job.

The receiving server 102 includes four subsystems of a job receiving subsystem 105 for receiving the batch job execution request, a job distribution subsystem 106 for selecting an execution server to execute the job, an operation data extraction subsystem 107 for recording the operation data, and a job information update subsystem 108 for updating the batch job characteristics. These four subsystems are linked with each other.

Each of the execution servers 103-1, 103-2, . . . , 103-N include four subsystems of a job execution subsystem 109 for executing the batch job, an operation data extraction subsystem 110 for recording the operation data, a performance information collection subsystem 111 for collecting server load information, and a server information extraction subsystem 112 for updating the contents of the repository 104 based on the collected server load information. These four subsystems are linked with each other.

Each of the receiving server 102 and the execution servers 103-1, 103-2, . . . , 103-N have four subsystems and the four subsystems may be realized by four independent programs operating in coordination or may be realized by one program comprising the four functions. Alternatively, a person skilled in the art can implement the subsystems in various embodiments such as combining two or three functions into one program or realizing one function by a plurality of linked programs. Details of contents of processes performed by four subsystems are to be hereinafter described.

FIG. 5 is an example of storing the operation data. The operation data is data stored in the repository 104 and indicates the operation status of the batch system 101. Although FIG. 5 shows an example represented in a table, the actual data can be stored in a form other than a table. As described later, the operation data is recorded by the operation data extraction subsystem 107 in the receiving server 102 and the operation data extraction subsystem 110 in each of the execution servers 103-1, 103-2, . . . , 103-N.

The FIG. 5 is table has a “storage date and time” column indicating the date and time the records (i.e. rows) were stored, and a “record type” column indicating the types of records. The number and contents of the data items to be stored depend on the record types. For that reason, depending on the record type, used columns of the data items (“data item 1”, “data item 2” . . . ) are different from each other. Additionally, if the column is used, meanings of the stored data also differ from one another depending on the record type.

In the example of FIG. 5, four different types of records are present. The content of a first record has “2006/02/01 10:00:00.001” in the storage date and time, “10” (a code indicating the start of a series of processes relating to the batch job) in the record type, and “JOB 1” (identification name of the batch job) in the data item 1. The columns of the data item 2 and after are not used. The record indicates that the start of the batch job process denoted as JOB 1 was recorded at 2006/02/01 10:00:00.001. In the operation data, a record with the record type “10” is hereinafter referred to as “job start data”.

The content of a second record has “2006/02/01 10:00:00.050” in the storage date and time and “20” (a code indicating the prediction of an execution time and load of the batch job) in the record type, “JOB 1” in the data item 1, “1000” (the number of transactions i.e. the number of input data of JOB 1) in data item 2, “3300 seconds” (the predicted time required for execution of JOB 1) in the data item 3, “600.0 seconds” (the predicted amount of CPU usage or the predicted CPU occupancy time required for execution of JOB 1) in the data item 4, “9%” (the predicted CPU utilization to be increased by the execution of JOB 1) in the data item 5, and “4.5 MB” (the predicted amount of memory usage used by JOB 1) in the data item 6. The record indicates that the prediction of the time and load required for the execution of JOB 1 was recorded at 2006/02/01 10:00:00.050 and the contents of the prediction are recorded in the data item 2 and the following columns. Although the data item 7 and the following columns are not shown in the drawings, the necessary items are predicted depending on the embodiment, and the prediction result is stored. In the operation data, a record with the record type being “20” is hereinafter referred to as “job execution prediction data”.

The time required for the execution of the batch job and the CPU utilization have different predicted values depending on the execution server. In the drawings, however, the differences between each execution server are not shown. For example, if the difference in hardware of the execution servers 103-1, 103-2, . . . , 103-N is negligible, it is sufficient to record one CPU utilization in one data item. Meanwhile, if the hardware performance of each of the execution servers 103-1, 103-2, 103-N is so different that it is not negligible, the CPU utilization for each execution server is predicted, for example, and each predicted value may be stored in separate columns.

Alternatively, one CPU utilization is recorded as a reference, and the CPU utilization in each of the execution servers 103-1, 103-2, . . . , 103-N may be converted from the reference by a prescribed method.

The content of a third record has “2006/02/0110:55:30.010” in the storage date and time, “30” (a code indicating the end of the batch job execution) in the record type, “JOB 1” in the data item 1, “582.0 seconds” (the actual measurement of the amount of CPU used by JOB 1) in the data item 2, “10%” (the actual measurement of CPU utilization increased by JOB 1) in the data item 3, “4.3 MB” (the actual measurement of the amount of memory used by JOB 1) in the data item 4, “5%” (the actual measurement of the fraction of memory used by JOB 1) in the data item 5, and “16000” (the number of physical I/O generated by JOB 1) in the data item 6. The record indicates that the end of the execution of JOB 1 was recorded at 2006/02/01 10:55:30.010, and the actual measurements of the load required for the execution are recorded in the data item 2 and the following columns. Although the data item 7 and the following columns are not shown, the necessary items are measured depending on the embodiment, and the actual measurement is recorded. In the operation data, a record with the record type being “30” is hereinafter referred to as “job actual data”.

The content of a forth record has “2006/02/0110:55:30.100” in the storage date and time, “90” (a code indicating the end of the whole series of processes relating to the batch job) in the record type, and “JOB 1” in the data item 1. The column of the data item 2 and the following are not used. The record indicates that the end of the whole series of processes relating to JOB 1 was recorded at 2006/02/0110:55:30.100. In the operation data, a record with the record type being “90” is hereinafter referred to as “job end data”.

It should be noted that the operation data is not limited to the above four types, but an arbitrary type can be added depending on the embodiment. For example, data corresponding to the server load information shown in FIG. 7 can be recorded as the operation data. The data representation can be appropriately selected depending on the embodiment so that the record type can be represented in a form other than the numerical codes, for example. The data item recorded as the operation data can be arbitrarily determined depending on the embodiment. Examples of the data items are as follows: the input data volume (the number of input records), the amount of CPU usage, the CPU utilization, the amount of memory usage, the memory utilization, the number of the physical I/O issues, the amount of file usage, the number of used files, the file occupancy time, the user resource conflict, the system resource conflict and the waiting time when the conflict occurs.

FIG. 6 shows an example of storing the batch job characteristics. The batch job characteristics are data stored in the repository 104 and indicate the characteristics of the batch job. As described later, the batch job characteristics are generated/updated automatically. Consequently, unlike the conventional systems, system administrators do not need to take the time and effort to obtain the batch job characteristics. Additionally, one can always obtain the latest batch job characteristics. FIG. 6 is an example represented by a table; however, the actual data can be stored in a form other than the table. As described later, the batch job characteristics are recorded by the job information update subsystem 108 in the receiving server 102.

The FIG. 6 is table has a “job identification name” column indicating the identification name of the batch job, a “data type 1” column and a “data type 2” column indicating what characteristics are recorded in the record (row), and a “data value” column recording the characteristic value of the individual characteristics.

The example of FIG. 6 indicates the data types in a hierarchy by combining two columns of the data type 1 and the data type 2. The data type 1 and the data type 2 record coded numbers such as “10” (a code indicating the execution time) and “90” (a code indicating the actual measurement error) in the example of FIG. 6.

FIG. 6 lists types of “number of execution”, “execution time”, “CPU information”, “memory information”, and “physical I/O information” as the data types. The data values are recorded in subdivided types of the above types.

The input data volume (the number of input records), the amount of CPU usage, the CPU utilization, the amount of memory usage, the memory utilization, the number of the physical I/O issues, the amount of file usage, the number of used files, the file occupancy time, the user resource conflict, the system resource conflict, the waiting time when the conflict occurs and others can be used as the data type of the batch job characteristics. In accordance with the embodiment, the necessary data type can be used as the batch job characteristics.

Note that FIG. 6 shows the characteristics of the batch job with the identification name being “JOB 1” alone; however, in practice, the characteristics of a plurality of batch jobs are stored. Many rows in the example of FIG. 6 have values converted into the value per transaction recorded in the data value column; however, the data value not converted into the value per transaction may be recorded depending on the data type property. It is predetermined whether a value is converted into the value per transaction in accordance with the data type represented by combining the data type 1 and the data type 2. The data representation can be selected arbitrarily depending on the embodiment. For example, the data type can be represented in a form other than numerical codes or in one column.

The items shown in FIG. 6 as the data type are not mandatory, but some of the items alone may be used. Or, other data types not described in FIG. 6 may be recorded. However, since the batch job characteristics are generated from the operation data (FIG. 5) by a method explained later, the items used as the batch job characteristics need to be recorded at the time of operation data generation.

If the difference in the hardware performance of the execution servers 103-1, 103-2, . . . , 103-N is not negligible, in some cases the batch job characteristics of some data types should be recorded for each execution server. For example, because the execution time and the CPU utilization etc. are influenced by the hardware performance of the execution server, these items of the batch job characteristics are desirable to be recorded for each execution server in some cases. On the other hand, because the amount of memory usage and the number of physical I/O issues etc. are not normally influenced by the hardware performance of the execution server, these items of the batch job characteristics does not need to be recorded for each execution server.

FIG. 7 is an example of storing the server load information. The server load information is data stored in the repository 104, and indicates the load status of each of the execution servers 103-1, 103-2, . . . , 103-N. Although FIG. 7 is an example represented in a table, the actual data may be stored in a form other than a table. As described later, the server load information is collected by the performance information collection subsystem 111 in each of the execution servers 103-1, 103-2, . . . , 103-N, and is recorded by the server information extraction subsystem 112. If the data of FIG. 7 is displayed in a graph, a line plot similar to that of FIG. 3 can be obtained.

FIG. 7 is table has a “server identification name” column indicating the execution server identification name, an “extraction time period” column indicating the time of measuring the load status of the execution server and storing the load status in the record (row) as server load information, a “data type 1” column and a “data type 2” column indicating the load information type, and a “data value” column recording the actual measurement of the individual load information.

The premise of the example of FIG. 7 is explained first. FIG. 7 is an example when the load statuses of the execution servers 103-1, 103-2, . . . , 103-N are measured every 10 minutes and are recorded as the server load information. FIG. 7, in addition, is based on the premise that “since most of batch jobs relate to day-by-day operations, the execution server load changes in one-day period, and the load is approximately the same amount at the same time of any day”.

Based on the above premise, the server load information is measured and recorded every 10 minutes everyday from 00:00 to 23:50, for example. Because of the premise that the load at a certain time of a day is approximately the same amount at the same time of any day, the process overwrites the record of the same time of the previous day. The data at the latest measurement time, additionally, is recorded separately as a special “latest state” data. In other words, in each of the execution servers 103-1, 103-2, . . . , 103-N, 145 data blocks ((60÷10)×24+1=145) are recorded (The data block hereinafter indicates a plurality of rows grouped for every value of the extraction time period shown as in FIG. 7). For example, at 00:30, the block of 00:30 where the server load information was recorded at 00:30 of the previous day is overwritten. At the same time the “latest state” block where the server load information was recorded 10 minutes before, i.e. at 00:20, is overwritten. In other words, the content of the data value of the “latest state” block is the same as one of the rest of 144 blocks.

As described above, the server load information is recorded at a specific time point. Because the server load status at a specific time point can be considered as representative of that of a certain time period, the recorded server load information can be considered as a representation of the certain period. For example, the server load information recorded every 10 minutes can be considered as a representation of the load status of 10-minute period. Therefore, the server load information may have an item of “extraction time period”.

In the following description, the individual data recorded as above is explained using an example of a 00:10 block in FIG. 7. In the block, a result obtained at 00:10 by measuring the load status of the execution server with the server identification name being “SVR 1” is recorded. The server identification name “SVR 1” indicates one of the execution servers 103-1, 103-2, . . . , 103-N. The load information indicating the load status, specifically, shows that the CPU utilization is 71%, the amount of memory usage is 1.1 GB, the amount of hard disk usage (“/dev/hda” in FIG. 7 indicates a hard disk) is 8.5 GB, and the average waiting time of the physical I/O is 16 ms. In addition, the total memory size loaded on SVR 1 is 2 GB and the total hard disk capacity is 40 GB etc. is also recorded. The utilization and free space can be calculated from the total capacity and the used capacity.

The measurement and record can be performed in an interval other than 10 minutes depending on the embodiment. In practice, there are batch jobs executed in other cycles such as a weekly period operation and a monthly period operation. Therefore, the extraction date and time rather than the extraction time period (extraction time) may be recorded. In such a case, it is favorable to accumulate the appropriate amount of the server load information in accordance with the period rather than accumulating the server load information of a nearest day (i.e. 24 hours) alone as in the above example. For example, it is desirable that when the batch system 101 is influenced by each period of the monthly operation, weekly operation, and daily operation, the server load information for one month, which is the longest period, is accumulated, and the block at the same time in the previous month is overwritten. Note that an appropriate period varies depending on the embodiment; however, in general, since a number of batch jobs are executed regularly, the load status of the execution servers has periodicity to a certain extent.

The items shown in FIG. 7 as the data type are not mandatory to be used, but some of the items alone can be used. The other data types not shown in FIG. 7 can also be recorded. For example, among the CPU utilization and the amount of CPU usage, the memory utilization, the amount of memory usage, the average waiting time of the physical I/O, the amount of file usage, the free space in the storage device, and others necessary data types can be recorded as server load information depending on the embodiment. However, the server load information is required to be recorded in association with the time, although the time period may be different depending on the embodiment. The hardware resource such as the total memory size and the total hard disk capacity does not change without adding hardware etc., and thus, the resource may be recorded separately in the repository 104, for example, as static data different from the server load information rather than recording for every 10 minutes as server load information.

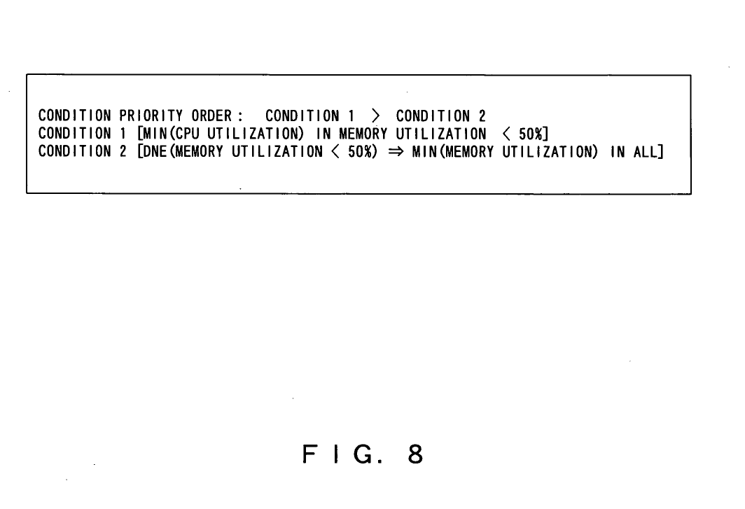

FIG. 8 is an example of the distribution conditions. The distribution conditions are data stored in the repository 104, and are rules referred to when selecting a server executing the batch job. The present invention is under an assumption that the distribution conditions are determined in advance by some methods, and are stored in the repository 104.

FIG. 8 shows two distribution conditions of a “condition 1” and a “condition 2”, and a priority order such that condition 1 should be applied prior to condition 2's designation. Condition 1 says to “select a server with the lowest CPU utilization among servers with the memory utilization less than 50%”. Condition 2 indicates that “if a server with the memory utilization less than 50% does not exist, select a server with the lowest memory utilization”. In a case of the example, because condition 1 is determined prior to condition 2, the same result can be obtained if condition 2 is replaced by a rule “MIN (memory utilization) IN ALL”, which says to “select a server with the lowest memory utilization”.

FIG. 8 is an example of the distribution conditions for comparing a plurality of execution servers and for selecting anexecution server that satisfies the conditions. However, fixed constraint conditions, such as “a server with the memory utilization being 50% or higher must not be selected”, may be imposed to each execution server rather than a relative comparison with the other execution servers. Generally, in many cases the execution servers 103-1, 103-2, . . . , 103-N execute online jobs in addition to the batch jobs. Therefore, in order to secure a certain amount of hardware resources for the online job execution, the above fixed constraint conditions can be determined in advance as the distribution conditions.

It should be noted that the distribution conditions can be represented by an arbitrary format other than the one shown in FIG. 8, depending on the embodiment.

FIG. 9 is a flowchart of the process executed by the batch job system 101. The process of FIG. 9 is a process executed for each batch job.

In step S101, the job receiving subsystem 105 of the receiving server 102 receives a batch job execution request. The batch job in the flowchart of FIG. 9 is hereinafter referred to as the current batch job. Step S101 corresponds to (1) of FIG. 4. The batch job execution request is provided from outside of the batch system 101. Assume that, even in a case where adjustment of the execution order according to the priority is required among the jobs, the adjustment has performed outside the batch system 101. In other words, the present invention is under a premise that the batch job execution requests are processed one by one in the order of the reception of the execution request by the job receiving subsystem 105.

In step S102 for the current batch job, the job receiving subsystem 105 requests the operation data extraction subsystem 107 to add the job start data (FIG. 5) to the operation data in the repository 104. Afterwards, the process proceeds to step S103. Step S102 corresponds to (2) of FIG. 4.

In step S103, the operation data extraction subsystem 107 adds the job start data to the operation data. In other words, the job start data is recorded in the operation data in the repository 104. Afterwards, the process proceeds to step S104. Step S103 corresponds to (3) of FIG. 4.

In step S104, the job receiving subsystem 105 requests the job distribution subsystem 106 to select an execution server executing the current batch job from the execution server group 103 and to cause the selected execution server to execute the current batch job. Afterwards, the process proceeds to step S105. Step S104 corresponds to (4) of FIG. 4.

In step S105, the job distribution subsystem 106 predicts the time required for the execution of the current batch job and determines an optimal execution server within the predicted time. Here, assume that the execution server 103-s is selected (1≦s≦N). Details of the process in step S105 are explained in combination with FIG. 10. Additionally, in step S105, the job distribution subsystem 106 predicts the resources required for the current batch job execution (such as time and the amount of memory usage) and the operation data extraction subsystem 107 adds (or records) the job execution prediction data (FIG. 5) to the operation data in the repository 104. Afterwards, the process proceeds to step S106. Step S105 corresponds to (5) of FIG. 4.

In step S106, the job distribution subsystem 106 requests the current batch job execution to the job execution subsystem 109 in the execution server 103-s. Here, communication between the receiving server 102 and the execution server 103-s is performed. Afterwards, the process proceeds to step S107. Step S106 corresponds to (6) of FIG. 4.

In step S107, the job execution subsystem 109 in the execution server 103-s requests the performance information collection subsystem 111 in the execution server 103-s to record data corresponding to the batch job characteristics data of the current batch job. Specifically, the job execution subsystem 109 requests to measure and record the data values of the data items (e.g. the amount of memory usage) included in the job actual data of the operation data (FIG. 5) by monitoring the load of the execution server 103-s resulted from the execution of current batch job. The job execution subsystem 109 executes the current batch job and the performance information collection subsystem 111 monitors the load of the execution server 103-s resulted from the execution. When the execution of the current batch job ends normally, the process proceeds to step S108. Step S107 corresponds to (7) of FIG. 4.

In step S108, the performance information collection subsystem 111 requests the operation data extraction subsystem 110 to record the job actual data based on the load status monitored by the performance information collection subsystem 111, and then provides the monitored data to the operation data extraction subsystem 110. Based on the request, the operation data extraction subsystem 110 adds (or records) the job actual data to the operation data in the repository 104. The process proceeds to step S109. Step S108 corresponds to (8) of FIG. 4.

In step S109, the job execution subsystem 109 notifies the job receiving subsystem 105 of the end of the execution of the current batch job. In this step, like step S106, communication is shared between the receiving server 102 and the execution server 103-s. Afterwards, the process proceeds to step S110. Step S109 corresponds to (9) of FIG. 4.

In step S110, for the current batch job, based on the notification, the job receiving subsystem 105 requests the operation data extraction subsystem 107 to add the job end data (FIG. 5) to the operation data in the repository 104. Based on the request, the operation data extraction subsystem 107 adds (or records) the job end data to the operation data in the repository 104. The process proceeds to step S111. Step S110 corresponds to (10) of FIG. 4.

In step S111, the job receiving subsystem 105 requests that the job information update subsystem 108 updates the batch job characteristics in the repository 104. The process proceeds to step S112. Step S111 corresponds to (11) of FIG. 4.

In step S112, the job information update subsystem 108 updates the batch job characteristics of the current catch job. In other words, the storage content of the repository 104 is updated. The update is performed based on the job actual data recorded in step S108, and the details are described later. After the execution of step S112, the process ends. Step S112 corresponds to (12) of FIG. 4.

FIG. 10 is a flowchart showing the details of the process to determine the batch job execution server as performed in step S105 of FIG. 9. The process of FIG. 10 is executed by the job distribution subsystem 106 in the receiving server 102.

The parameters used in FIG. 10 are explained first. As in FIG. 3, t₁ and t₂ are time indicating the batch job execution range. In other words, t₁ is the scheduled starting time of the batch job, and t₂ is the predicted ending time of the batch job execution. j is a subscript for designating an execution server 103-j from the execution server group 103. The number of data type of the server load information (FIG. 7) is represented by L. k is a subscript for designating the data type of the server load information. j and k are used as subscripts in Mⱼₖ, Sⱼₖ, Dⱼₖ, Cⱼₖ, Aⱼₖ, Xⱼₖ, and Yⱼₖ as explained later. These parameters are stored in a register or memory in CPU (Central Processing Unit) of the receiving server 102, and are referenced and updated.

In step S201, the repository 104 is searched to determine whether or not the batch job characteristics (FIG. 6) corresponding to the current batch job are stored in the repository 104. If they are stored, the batch job characteristics are stored in the memory etc. in the receiving server 102.

In step S202, based on the result determined in step S201, it is determined whether the batch job characteristics corresponding to the current batch job are present or absent. If they are present, the determination is Yes, and the process moves to step S203. If they are absent, the determination is No, and the process moves to step S214.

In step S203, the input data volume of the current batch job is obtained. Based on the input data volume and the batch job characteristics stored in step S201, the time required for the current batch job execution is predicted. The input data volume can be represented by the number of transactions, for example, or may be represented by volume on the basis of a plurality of factors, such as the number of transactions and the number of data items included in one transaction. For example, if input data is provided in a form of a text file and input data of one transaction is written in one line, the number of lines of the text file is obtained and can be used as the input data volume.

For example, in the example of batch job characteristics of FIG. 6, the execution time of JOB 1 is 3.3 seconds per transaction. Therefore, if the current batch job is JOB 1 and is provided with 1000 transactions as input data volume, in the present embodiment, the time required for the current batch job execution can be predicted as 3300 seconds. This prediction is performed by multiplying 3.3 and 1000 in the CPU of the receiving server 102. In the other embodiments, a calculation other than multiplication can be used. Since the scheduled starting time of the current batch job execution t₁ can be determined using an appropriate method depending on the embodiment, according to the prediction, the predicted time of the end of the batch job execution t₂ is determined (In this example, t₂ is 3300 seconds after t₁). After the end of step S203, the process proceeds to step S204.

In step S204; 0 is assigned to the subscript j designating the execution server for initialization. The process then proceeds to step S205.

An iteration loop is formed by each step from step S205 to step S211. In step S205, 1 is added to j, first, and the execution server 103-j is selected as server load prediction target. The process proceeds to step S206.

In step S206, in the server load information (FIG. 7) stored in the repository 104, the data corresponding to the execution server 103-j in the “latest state” block and in the blocks corresponding to the execution range of the current batch job is loaded. The data is then stored in memory etc. of the receiving server 102. The server load information of FIG. 7 is an example under the premise that approximately the same load status is repeated in a one-day period. In this example, in step S206, the server load information of the blocks of the time within the time range from t₁ to t₂ is loaded. The loaded server load information of the blocks of each time is information based on past performance. In this step, the loaded server load information is used to obtain the predicted value of the server load information within the time range from t₁ to t₂ in the future. In the present embodiment, the raw loaded server load information of blocks of each time is used as the predicted value of the server load information at the corresponding time in the future.

In an embodiment with a different period of server load status change, appropriate data in accordance with the period is loaded. For example, in a case of the monthly period, the server load information is accumulated for one month and the server load information of the blocks of the time within the time range from t₁ to t₂ of the day of the previous month is loaded. When the necessary data is loaded, the process proceeds to step S207.

In step S207, the mean value of the load of the execution server 103-j in the execution range of the current batch job is calculated for each server load information data type. The mean value calculated on the k-th data type in L data types is assigned as Mⱼₖ and is stored in the memory etc. of the receiving server 102. As described in the explanation of FIG. 3, the mean value of the server load in the execution range of the current batch job can be used instead of the total loading amount over the execution range of the current batch job. Using the former or the latter, the same determination result can be obtained. For that reason, in step S207, the mean value is calculated. Note that the data loaded in step 206 is the server load information in the past and the calculated mean value Mⱼₖ is a prediction of the mean of the load in the future (in the time range from t₁ to t₂) based on the data in the past.

The server load's mean value calculated in step S207 is the mean value in the current batch job's execution range. This fact is the feature of the present invention. By having this feature, compared with the conventional systems, the further appropriate selection of the batch job execution server can be performed and the distribution efficiency can be improved. In other words, by considering the load status over the execution range of the current batch job rather than by considering the server load status immediately prior to the execution of the batch job alone as in the conventional systems, further appropriate selection can be achieved. Because the range for calculation of the mean value Mⱼₖ is a specific time range, which is the execution range of the current batch job, compared with the load status mean value within a roughly defined range unrelated to the current batch job execution range, such as the load status mean value for every month, for example, Mⱼₖ is an accurate predicted value.

Note that in the example of FIG. 7, the server load information is recorded every 10 minutes and the time t₁ and t₂ do not necessarily follow the 10 minutes interval. In such a case, an appropriate fraction process may be performed as needed.

When the mean values Mⱼₖ are calculated for all k where 1≦k≦L in step S207, the process proceeds to step S208. Step S208 to step S210 are steps used for the further accurate determination of an optimal execution server in designating the future time close to when the process of FIG. 10 is being executed as t₁.

In step S208, for each server load information data type, the difference Dⱼₖ between the mean value Mⱼₖ and the data value Sⱼₖ of the server load information at the time t₁ is calculated. It can also be represented as Dⱼₖ=Mⱼₖ−Sⱼₖ. It should be noted that because the server load information is recorded at a certain interval, data from same time as time t₁ is not necessarily present. In such a case, Sⱼₖ can be calculated by interpolation of the interval between the server load information before the time t₁ and after the time t₁, or can be substituted by the server load information at the time immediately before or immediately after the time t₁. When the difference Dⱼₖ for all k where 1≦k≦L is calculated, the process proceeds to step S209.

In step S209, for all k where 1≦k≦L, Dⱼₖ is added to the data value Cⱼₖ of the k-th data type of the server load information in the block of the latest state loaded in step S206 to calculate Aⱼₖ. Aⱼₖ corresponds to the value, which is Mⱼₖ corrected in order to improve the reliability. The reason for the improvement is provided below.

As clear from the operations in step S206 through step S208, Mⱼₖ and Sⱼₖ are values calculated based on the data in the past. The present invention premises that the load status of the execution server has periodicity and the future load status can be predicted from the load information in the past by using the periodicity. However, the prediction has errors. Meanwhile, since Cⱼₖ is the latest actual measurement, the information is highly reliable. As above, t₁ is the time close to the point in time the process of FIG. 10 is being executed, and therefore, it is also close to the time of recording Cⱼₖ. Hence, by correcting the load information Sⱼₖ at the time t₁ calculated based in the data in the past to the actual measurement Cⱼₖ, the enhanced reliability of the information is expected. On the other hand, the data necessary for the selection of the execution server is the mean value of the load of the execution server 103-j in the execution range of the current batch job rather than Cⱼₖ. Hence, from the relation between Sⱼₖ and Cⱼₖ, Aⱼₖ is calculated by correcting Mⱼₖ. From the above explanation, Aⱼₖ can be represented by Aⱼₖ=Cⱼₖ+Dⱼₖ=Cⱼₖ+Mⱼₖ-Sⱼₖ=Mⱼₖ+(Cⱼₖ−Sⱼₖ), and it corresponds to the value of the corrected Mⱼₖ. In other words, Aⱼₖ is a value predicted as the mean value of the load of the execution server 103-j in the execution range of the current batch job and is a value after the correction in order to improve accuracy.

For example, in a case as in FIG. 7, where the server load status changes in one-day period and the server load information is recorded every 10 minutes, if the point in time for execution of the process of FIG. 10 is 10:12, t₁ is 10:14, and t₂ is 11:30, the “latest state” server load information is recorded at 10:10. That is, Cⱼₖ is the actual measurement at 10:10. Meanwhile, Mⱼₖ and Sⱼₖ are the values based on the server load information of the previous day. Therefore, calculating Aⱼₖ as above can improve the accuracy of the predicted value of the mean value of the load of the execution server 103-j in the execution range of the current batch job.

After calculating Aⱼₖ for all k where 1≦k≦L in step S209, the process proceeds to step S210.

In step S210, for all k where 1≦k≦L, the load Xⱼₖ caused by the execution of the current batch job is predicted using the batch job characteristics of the current batch job. The batch job characteristics of the current batch job have already been stored in the memory etc. in step S201. The load status of the execution server 103-j in the execution range of the current batch job when executing the current batch job is predicted for all k where 1≦k≦L, based on the Xⱼₖ and Aⱼₖ. The predicted value is stored as Yⱼₖ.

For example, in the example of the batch job characteristics of FIG. 6, if the current batch job is JOB 1, and the k-th data type is the number of the physical I/O issues, Xⱼₖ is predicted at least based on the data value of “16 issues”. In addition, depending on the embodiment, the prediction of Xⱼₖ may take into account the time of the execution range of the current batch job, the number of transactions, and the actual measurement error (corresponding to the actual measurement error “2.1 issues” relating to the number of physical I/O issues of FIG. 6 in the above example) etc. For example, if the number of transactions is 1000 in the above example, the calculation may be made as Xⱼₖ=(16+2.1)×1000÷(t₂−t₁), and Yⱼₖ=Aⱼₖ+Xⱼₖ, and these can be used as the predicted values of Xⱼₖ and Yⱼₖ. Of course, an arbitrary calculation method other than above example can be employed for the prediction.

In addition, if the difference in hardware performance of the execution servers 103-1, 103-2, . . . , 103-N is negligible, the values Xⱼₖ for all j where 1≦j≦N are considered to be equal. In such a case, Xⱼₖ does not have to be calculated every time the process in step S210 is executed in the iteration loop from step S205 to step S211. Xⱼₖ where j=1 (=Xₗₖ) alone should be calculated and the calculated and stored Xₗₖ can be used as Xⱼₖ where j>1.

When Yⱼₖ is calculated for all k where 1≦k≦L in step S210, the process proceeds to step S211.

In step S211, it is determined if the load status in the execution range of the current batch job when executing the current batch job is calculated for all execution servers. In other words, it is determined if j=N or not. If the calculation has been performed for all execution servers (j=N), the determination is Yes and the process proceeds to step S212. If not (j<N), the determination is No and the process returns to step S205. Note that it is obvious from steps S204, S205, and S211 that j>N cannot occur.

In step S212, the execution server of the current batch job is determined according to Yⱼₖ calculated in step S210 and the distribution conditions stored in the repository 104. When the distribution conditions are the same as FIG. 8, using “condition 1” first, an execution server with the lowest CPU utilization among the execution servers with less than 50% memory utilization is searched. Suppose that the memory utilization is the m-th data type and the CPU utilization is the c-th data type in the batch job characteristics. A set of j where Yⱼₘ<50% among all Yⱼₘ where 1≦j≦N is obtained. If the set is not empty, j, which gives the minimum Y_{jc}, is obtained. The obtained value is designated as s, and the execution server 103-s is selected as the execution server of the current batch job. If j where Yⱼₘ<50% is not present, “condition 2” is used, i.e. an execution server with the lowest memory utilization is searched. In other words, j, which gives the minimum Yⱼₘ, is obtained from the all j where 1≦j≦N. The obtained value is designated as s, and the execution server 103-s is selected as the current batch job's execution server. When the execution server 103-s is selected by “condition 1” or “condition 2”, the process moves to step S213.

In step S213, the job distribution subsystem 106 causes the operation data extraction subsystem 107 to add the job execution prediction data to the operation data (FIG. 5) in the repository 104. The items recorded as job execution prediction data is the same as is explained in FIG. 5. Those items correspond to all or a part of Xₛₖ (1≦k≦L) as calculated in step S210. After executing step S213, the process ends.

If the determination is No in step S202, the process moves to step S214. Step S214 through step S216 are steps for exceptional processes. In regards to the server load information (FIG. 7), most batch jobs are executed regularly. On the other hand, the determination is No in step S202 when the batch job characteristics corresponding to the current batch job are not recorded in the repository 104. In other words, it is where the batch job is executed only once or is executed for the first time and is an exceptional case. If this is the second execution of a batch job or more, then the batch job characteristics (FIG. 6) have already been recorded in the repository 104 in the first execution in step S112 of FIG. 9. Therefore, the determination in step S202 should be Yes, and the process in step S214 is not performed. Depending on the embodiment, there may be an option where a system administrator etc. can manually designate the batch job characteristics. In such a case, the determination in step S202 may be Yes, because the batch job characteristics for a batch job to be executed for the first time may be recorded in advance.

In step S214, 0 is assigned to the subscript j designating the execution server for initialization. The process proceeds to step S215.

An iteration loop is formed by each step from step S215 to step S216. In step S215, 1 is added to j first. Then among the server load information stored in the repository 104, the data of the “latest state” block of the execution server 103-j is loaded. The data value corresponding to k-th data type of the execution server 103-j is designated as Yⱼₖ and is stored in the memory etc. of the receiving server 102. After Yⱼₖ for all k where 1≦k≦L are stored, the process moves on to step 216.

In step S216, it is determined whether or not the server load information of the “latest state” blocks of all execution servers is loaded. In other words, it is determined if j=N or not. If the server load information for all execution servers has been loaded (j=N), the determination is Yes, and the process moves to step S212. If not (j<N), the determination is No, and the process returns to step S215. Note that j>N cannot occur.

As described above, in step S212, the execution server is selected in accordance with the distribution conditions. In other words, the process of moving from step S216 to step S212 is the same as the conventional methods so that the execution server of the batch job is selected based on the load status, which is close to the point in time when the batch job execution request is issued, alone.

As is clear from the descriptions on FIG. 3, FIG. 5, and FIG. 6, if the difference in hardware performance of the execution servers 103-1, 103-2, . . . , 103-N is not negligible, the prediction in step S203 may have to be performed individually for each execution server. In such a case, the range of the blocks of the data loaded in step S206 is also influenced. It is also possible to add a process to exclude the execution server with a long execution time predicted in step S203 from performing as the execution server to execute the current batch job.

For example, an execution server with the predicted execution time longer than a prescribed threshold may be excluded, or the predicted execution time is compared among those in the execution server group 103 and the execution server excluded may be determined from the relative order etc. Alternatively, a condition regarding the execution time may be included in the distribution conditions used in step S212.

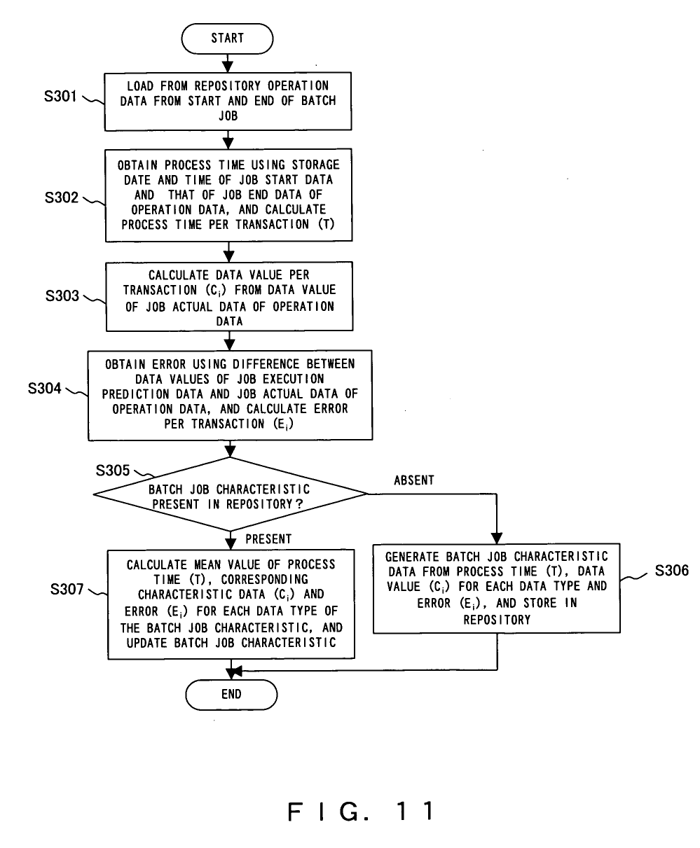

FIG. 11 is a flowchart showing details of the process for updating the batch job characteristics (FIG. 6) based on the operation data (FIG. 5) performed in step S112 of FIG. 9. The process of FIG. 11 is executed by the job information update subsystem 108 in the receiving server 102.

In step S301, from the operation data (FIG. 5) stored in the repository 104, the job start data, the job execution prediction data, the job actual data, and the job end data of the current batch job are loaded and stored in the memory etc. of the receiving server 102. Afterwards the process proceeds to step S302.

In step S302, the current batch job's process time is calculated using the difference between the storage date and time of the job end data and that of the job start data. Afterwards, the process time per transaction T is calculated and the process proceeds to step S303. Depending on the embodiment, process time or T of the current batch job is recorded in the job actual data so that it may be loaded in step S302. T may be calculated by dividing the difference between the storage date and time of the job end data and that of the job start data by the number of transactions. Alternatively, other methods can be employed to calculate T (in a case of, for example, the batch job including a process, which requires a certain time period regardless of the number of input data).

In step S303, among the data items of the job actual data loaded in step S301, the data value per transaction is calculated for items to be recorded as the batch job characteristics. When the number of data types to be recorded as the batch job characteristics is designated as B, for all i where 1≦i≦B, a data value per transaction Cᵢ is calculated based on the data value in the job actual data corresponding to the i-th data type and the number of transactions. Cᵢ can be obtained by dividing the data value in the job actual data corresponding to the i-th data type by the number of transactions, for example. For the data type, to which a simple division is not applicable, other methods can be employed for the calculation. For example, simple division is not applicable to the amount of memory usage in some cases since the amount of memory usage includes a part used regardless of the number of transactions, such as program load and a part used approximately in proportion to the number of transactions. When Cᵢ for all i where 1≦i≦B is calculated, the process proceeds to step S304.

In step S304, a prediction error per transaction Eᵢ corresponding to the i-th data type is calculated for all i where 1≦i≦B. Specifically, the data values of the data items corresponding to the i-th data type are obtained for each of the job execution prediction data and the job actual data loaded in step S301, and the difference of the two data values are calculated. Based on the difference and the number of transactions, the prediction error per transaction Eᵢ is calculated. Like Cᵢ, Eᵢ can be calculated by division; however, other calculation methods can be also employed. When Eᵢ is calculated for all i where 1≦i≦B, the process proceeds to step S305.

In step S305, it is determined if the batch job characteristics of the current batch job are present in the repository 104. When it is present, the determination is Yes, the process proceeds to step S307. When it is absent, the determination is No, the process proceeds to step S306. The determination is the same as that of step S201 and step S202 of FIG. 9. The determination is No if the batch job is executed only once or the batch job is executed for the first time.

In step S306, the batch job characteristics data of the current batch job are generated from T, Cᵢ, and Eᵢ and are added to the repository 104. Depending on the batch job characteristics' data type, the values of T, Cᵢ, and Eᵢ are used as the data values of the batch job characteristics without any processing or may be used after some processing.

In step S307, the batch job characteristics of the current batch job are updated based on T, Cᵢ and Eᵢ. For example, in the embodiment, which records the mean value in the past as the batch job characteristics, the batch job characteristics are updated to the weighted mean values of the currently recorded data values of the batch job characteristics and any value of T, Cᵢ, or Eᵢ corresponding to the data type of each data value. The weight used for the weighted mean values can be determined, for example, according to the total number of transactions in the past recorded as the data of the batch job characteristics and the number of transactions in execution of the current batch job. In another embodiment, also, the values of T, Cᵢ, and Eᵢ at the latest execution itself may be recorded as the batch job characteristics. In further embodiment, the values of T, Cᵢ, and Eᵢ in the previous n-times of executions (n is a predetermined constant) immediately before the current batch job are recorded as the batch job characteristics, and the mean values of the n-times data may be recorded in addition to the values above. All embodiments shares a point that the update based on T, Cᵢ and Eᵢ is performed in step S307.

After the end of step S306 or step S307, the update process of the batch job characteristics ends.

According to the present invention, since the batch job characteristics are recorded and updated automatically as described above, correct acquisition of the batch job characteristics, which was difficult by the conventional systems, is facilitated. Since the batch job characteristics are updated for every batch job execution, even if the batch job characteristics change due to the change in operation of the batch job, the batch job characteristics can be automatically updated in accordance with the change.

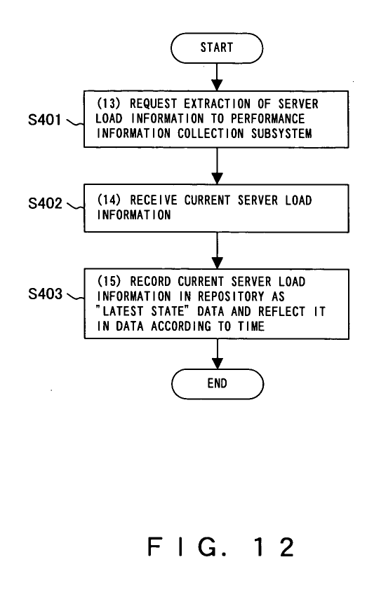

FIG. 12 is a flowchart showing the details of the process for recording the server load information (FIG. 7) to the repository 104. The process of FIG. 12 is executed by the performance information collection subsystem 111 and the server information extraction subsystem 112 in each of the execution servers 103-1, 103-2, . . . , 103-N at certain intervals. The certain intervals are the intervals manually set by a system administrator etc. of the batch system 101 or intervals predetermined as a default value of the batch system 101. In the example of FIG. 7, the intervals are 10 minutes.

In the following description, for purpose of simplicity, an example of a process performed in the execution server 103-a (1≦a≦N) at time t is explained.

In step S401, the server information extraction subsystem 112 of the execution server 103-a requests the performance information collection subsystem 111 of the execution server 103-a to extract the load information of the execution server 103-a. Afterwards, the process proceeds to step S402. The step S401 corresponds to (13) of FIG. 4.

In step S402, the performance information collection subsystem 111 extracts the current load information of the execution server 103-a and returns the result to the server information extraction subsystem 112. The information extracted at this point is a data value corresponding to each data type of the server load information of FIG. 7. Afterwards, the process proceeds to step S403. Step S402 corresponds to (14) of FIG. 4.

In step S403, the server load information in the repository 104 is updated based on the data that the server information extraction subsystem 112 received in step S402. In the case of one-day period as in the example of FIG. 7, the “latest state” block and the time t block among blocks of the server identification name of the execution server 103-a are updated. First, the data value corresponding to each data type of “latest state” block is rewritten to the data value received in step S402. Next, the time t block is updated; however, the updating method varies depending on the embodiment. In an embodiment, the data value corresponding to each data type of the time t block is rewritten to the data value received in step S402. In other words, every time the latest actual measurement is obtained, it is recorded as the server load information. In another embodiment, a value is calculated by a prescribed method (for example, a weighted mean value by a prescribed weighting) based on both the data currently recorded in the time t block and the data received in step S402 and the calculated value is recorded as the data value corresponding to each of the data type of the time t block.

After the process of step S403, the process for updating the server load information ends.

Note that the block to be updated in step S403 varies depending on the time period to accumulate the server load information as in the explanation of FIG. 7.

In the embodiment other than the above, the server load information is recorded once in the repository 104 as the operation data (FIG. 5) in step S402 and the server load information is updated by converting the operation data into a form of the server load information in step S403. In such a case, both of the batch job characteristics and the server load information are generated base on the operation data.

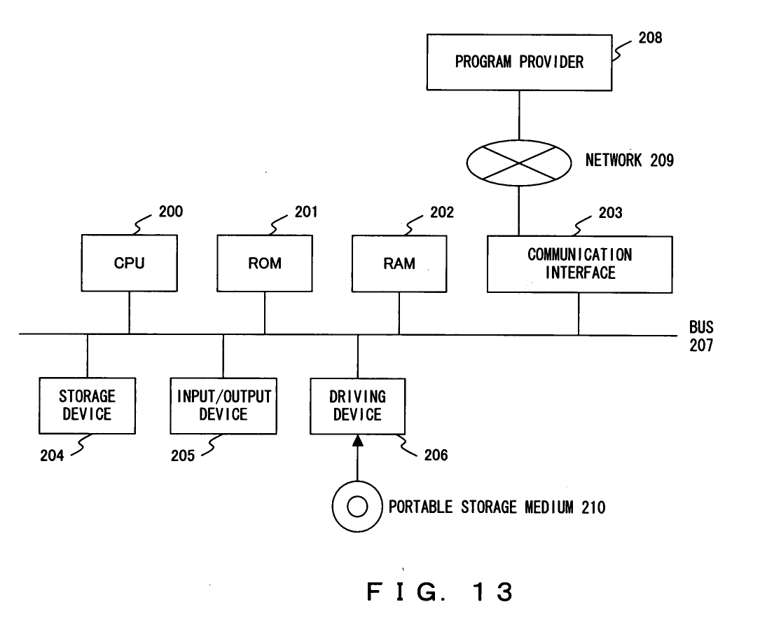

Each of the receiving server 102 and the execution servers 103-1, 103-2, . . . , 103-N constituting the batch job system 101 according to the present invention are realized as a common information processor (computer) as shown in FIG. 13. Using such an information processor, the present invention is implemented and the program for the present invention realizing the functions such as the job distribution subsystem 106 is executed.

The information processor of FIG. 13 comprises a Central Processing Unit (CPU) 200, ROM (Read Only Memory) 210, RAM (Random Access Memory) 202, the communication interface 203, the storage device 204, the input/output device 205, and the driving device 206 of portable storage medium and are connected by a bus 207.

The receiving server 102 and each of the execution servers 103-1, 103-2, . . . , 103-N can communicate each other via the respective communication interface 203 and a network 209. For example, step S106 and step S109 etc. of FIG. 9 are realized by communication between servers. The network 209 is a LAN (Local Area Network) for example, and each server constituting the batch system 101 may be connected to a LAN via the communication interface 203.

For the storage device 204, various storage devices such as a hard disk and a magnetic disk can be used.

The repository 104 may be provided in the storage device 204 in any of the servers of the receiving server 102 or the execution server group 103. In such a case, the server, where the repository 104 is provided, performs the reference/update of the data in the repository 104 through the processes shown in FIG. 9 through FIG. 12 via the bus 207, and the other servers via the communication interface 203 and the network 209. Alternatively, the repository 104 may be provided in a storage device (a device similar to the storage device 204) independent of any of the servers. In such a case, in the processes shown in FIG. 9 through FIG. 12, each server performs the reference/update of the data in the repository 104 via the communication interface 203 and the network 209.

The program according to the present invention etc. is stored in the storage device 204 or ROM 201. The program is executed by CPU 200, resulting in the batch job distribution of the present invention being executed. During the execution of the program, data is read from the storage device in which the repository 104 is provided as needed. The data is stored in a register in CPU 200 or RAM 202 and is used for the process in CPU 200. The data in the repository 104 is updated accordingly.

The program according to the present invention may be provided from a program provider 208 via the network 209 and the communication interface 203. It may be stored in the storage device 204, for example, and may be executed by CPU 200. Alternatively, the program according to the present invention may be stored in a distributed commercial portable storage medium 210 and the portable storage medium 210 may be set to the driving device 206. The stored program may be loaded to RAM 202, for example, and can be executed by CPU 200. Various storage mediums such as CD-ROM, a flexible disk, an optical disk, a magnetic optical disk, and DVD may be used as the portable storage medium 210.

What is claimed is:

1. Computer-readable storage medium, used in a batch job receiving computer for selecting from a plurality of computers a computer to execute a batch job, and storing a program for causing the batch job receiving computer to execute:
an execution time prediction step to predict execution time required for execution of the batch job based on a characteristic of the batch job and input data volume provided to the batch job;
a load status prediction step to predict each of load statuses of the plurality of the computers in a time range with a scheduled execution start time of the batch job as a starting point and having the predicted execution time; and
a selection step to select a computer to execute the batch job from the plurality of the computers based on the predicted load status.

2. The storage medium according to claim 1, wherein
the program further cause the batch job receiving computer to execute a batch job characteristic update step to update the characteristic of the batch job based on information relating to a load occurred when the batch job is executed by the computer selected in the selection step.

3. The storage medium according to claim 2, wherein
the characteristic of the batch job is stored in advance or is stored after being updated in the batch job characteristic update step, and the stored characteristic of the batch job is read and used in the execution time prediction step.

4. The storage medium according to claim 1, wherein
in the load status prediction step, a load status for each of a plurality of times at a certain interval in the time range is predicted, and the load status in the time range is predicted based on the predicted load status at the plurality of the times.

5. The storage medium according to claim 4, with the load status prediction step comprising:
reading load information corresponding to each of the plurality of the times among load information representing load status in the past stored in association with time for each of the plurality of the computers; and
predicting the load status for each of the plurality of the times based on the read load information.

6. The storage medium according to claim 4, wherein
in the load status prediction step, load information representing the load status is a numeral representation, and the load status in the time range is predicted based on a mean value of the load information corresponding to the load status predicted for the plurality of the times.

7. The storage medium according to claim 1, wherein
in the load status prediction step, prediction is made further based on an actual measurement closest to a point in time of the execution of the load status prediction step among actual measurements of the load status of the plurality of the computers.

8. The storage medium according to claim 1, with the selection step comprising:
reading a rule stored in advance in a storage unit;
applying load information representing the load status predicted for each of the plurality of the computers to the rule; and
selecting one of the plurality of the computers based on each of the values of the load information and a relation between the load information according to the rule.

9. The storage medium according to claim 8, wherein
the load information comprises at least one type of information from CPU utilization, an amount of CPU usage, memory utilization, an amount of memory usage, an average waiting time of physical input/output, an amount of file usage, and empty space of a storage device of the plurality of the computers,
the rule comprises one or more distribution conditions with a predetermined priority order,
each of the distribution conditions is set so as to designate a computer fulfilling the distribution condition, if present, based on the order of the plurality of the computers according to a value of a prescribed type information comprised in the load information when the load information is applied, and
in the selection step, the load information is applied to the distribution condition in accordance with the priority order, and a computer designated first is selected.

10. The storage medium according to claim 1, wherein
the program further cause the batch job receiving computer to execute a batch job load prediction step to predict a batch job load caused by the execution of the batch job based on the characteristic of the batch job, and
in the selection step, selection is made further based on the batch job load.

11. A device for selecting a computer to execute a batch job from a plurality of computers, comprising:
a storage unit for storing a characteristic of the batch job and for storing load information representing a load status in the past for each of the plurality of the computers in association with time;
an execution time prediction unit for reading the characteristic of the batch job from the storage unit and for predicting execution time required for execution of the batch job based on the read characteristic of the batch job and input data volume provided to the batch job;
a load status prediction unit for reading the load information from the storage unit and for predicting each of load statuses of the plurality of the computers in a time range with a scheduled execution start time of the batch job as a starting point and having the predicted execution time based on the read load information; and
a selection unit for selecting a computer to execute the batch job from the plurality of the computers based on the predicted load status.

12. A method, used in a batch job receiving computer for selecting from a plurality of computers a computer to execute a batch job, comprising:
predicting execution time required for execution of the batch job based on a characteristic of the batch job and input data volume provided to the batch job;
predicting each of load statuses of the plurality of the computers in a time range with a scheduled execution start time of the batch job as a starting point and having the predicted execution time; and
selecting a computer to execute the batch job from the plurality of the computers based on the predicted load status.
